(19) United States
(12) Patent Application Publication
(10) Pub. No.: US 2011/0316511 A1
(43) Pub. Date: Dec. 29, 2011

(54) METHOD AND APPARATUS FOR DC-TO-DC CONVERSION

(75) Inventors: Meng Wang, Tianjin (CN); Song Jiang, Tianjin (CN)

(73) Assignee: FREESCALE SEMICONDUCTOR, INC., Austin, TX (US)

(21) Appl. No.: 13/092,164

(22) Filed: Apr. 22, 2011

(30) Foreign Application Priority Data
Jun. 24, 2010 (CN) 201010213286.3

(51) Int. Cl. G05F 1/618

(52) U.S. Cl. 323/285

(57) ABSTRACT

A direct current-to-direct current (‘DC-DC’) converter generates a pulse-width modulated (‘PWM’) control signal, and generates an output voltage from an input voltage as a function of a duty cycle of the PWM control signal. A feed-forward module controls both the duty cycle and a repetition rate of the PWM control signal as regressive functions of the input voltage so as to tend to compensate for variation in the input voltage.

### BACKGROUND OF THE INVENTION

The present invention is directed to a method and apparatus for direct current-to-direct current (‘DC-DC’) conversion.

A DC to DC converter is an electronic circuit that converts direct current from a source of power from one voltage level to another (or from one current level to another). For example, step-up (‘boost’) converters provide an output voltage greater than the input voltage from the power source, whereas step-down (‘buck’) converters provide an output voltage less than the input voltage. In the special case of a voltage regulator, the nominal output voltage of the DC to DC converter may be the same as the power source. DC-DC converters may be used, for example, in portable electronic devices or other mobile electronic devices, which are supplied with power from batteries, whose output voltage varies slowly as the battery discharges. They may also be used in complex integrated circuits (‘system-on-chip’ for example) where a common source of power supplies different circuit elements at different supply voltages, in which case the independent operation of the circuit elements may give rise to transients and other rapid variations in the individual supply voltages.

Electronic switch-mode DC-DC converters convert one DC voltage level to another, by storing the input energy temporarily and then releasing that energy to the output at a different voltage. The storage may be in magnetic field storage components, such as inductors or transformers and/or in electric field storage components, such as capacitors. In continuous current mode, the current and thus the magnetic field in the inductive energy storage never reach zero. Most DC-DC converters are designed to move power in only one direction, from the input to the output. However, a bi-directional DC-DC converter may be used to move power in either direction, for example in vehicle drive applications requiring regenerative braking.

A DC-DC switch-mode converter is designed to maintain the output voltage at a constant and predefined level with good regulation, even when subjected to fast changes of input voltage, or output current. One type of DC-DC switch-mode converter is a pulse-width-modulation (‘PWM’) DC-DC power converter, in which a train of control pulses is generated and the input energy is alternately stored during the ‘duty cycle’ proportion of the period of each control pulse, whose width is controlled, and is released to the output during the complementary proportion of the control pulse period.

A negative feedback control circuit may be used to regulate the output voltage against load and input voltage variations by sensing the output voltage and controlling the duty cycle as a function of the output voltage sensed. A negative feedback control circuit needs to detect a change in the output voltage and then try to reduce this change through the feedback path so that the negative feedback responds to a transient disturbance of the input voltage only after its effect has already appeared at least partially at the output.

A feed-forward control circuit may be used to regulate the output voltage against disturbances and variations of the input voltage, especially in some applications where the input voltage varies rapidly or over a wide range. A feed-forward control PWM DC-DC power converter monitors the disturbance or variation of input voltage, and adjusts the duty cycle of the control pulses so as to control the effect on the output voltage of the input disturbance. An ideal loss-free feed-forward control circuit would maintain a constant output voltage independent of output load variations but in practice, losses make the output voltage subject to load variations. A combination of both negative feedback and feed-forward techniques is able to achieve superior performance. Feed-forward control provides the main part of voltage regulation, and negative feedback is used to compensate for residual imperfections of the feed-forward control, such as sensitivity to output load variations.

It would be desirable to obtain improved efficiency in a DC-DC converter using feed-forward control.

### BRIEF DESCRIPTION OF THE DRAWINGS

The present invention is illustrated by way of example and is not limited by embodiments thereof shown in the accompanying figures, in which like references indicate similar elements. Elements in the figures are illustrated for simplicity and clarity and have not necessarily been drawn to scale.

FIG. 1 is a schematic block diagram of the basic structure of a boost converter to which the present invention can be applied,

FIG. 2 is a block schematic block diagram illustrating the basic structure of a buck converter to which the present invention can be applied;

FIG. 3 is a more detailed schematic block diagram of a boost converter in accordance with one embodiment of the invention, given by way of example;

FIG. 4 is a graph showing the variation over time of signals appearing in operation of a conventional PWM DC-DC power converter with feed-forward control;

FIG. 5 is a graph showing the variation with time of signals appearing in operation of the boost converter of FIG. 3;

FIG. 6 is a graph showing the variation over time of the signals of FIG. 5 for two different input voltages;

FIG. 7 is a schematic diagram of an example of a saw-tooth generator in the boost converter of FIG. 3; and

FIG. 8 is a schematic diagram of an example of an oscillator in the boost converter of FIG. 3.

### DETAILED DESCRIPTION OF THE INVENTION

FIG. 1 shows the basic structure of a boost converter 100 to which the present invention can be applied. The boost converter is connected to a source 102 of DC power at a voltage V_{IN} between a positive polarity input terminal 104 and ground and supplies DC power at a voltage V_{O}, greater than V_{IN}, to a load 106 connected between a positive polarity output terminal 108 and ground. The basic structure of the boost converter 100 comprises an inductor 110 connected in series between the input terminal 104 and a node 112, a diode 114 whose positive electrode is connected to the node 112 and whose negative electrode is connected to the output terminal 108, a switch 116 connected between the node 112 and ground, a control module 118 for controlling the ON/OFF state of the switch 116 and hence the duty cycle of the converter and a capacitor 120 for smoothing the output voltage. It will be appreciated that many variations on the basic structure shown are possible; for example the diode 114 may be replaced by a controlled switch element in a synchronous converter.

In operation of the boost converter 100 in continuous conduction mode, input energy is alternately stored in the inductor 110 when the switch 116 is closed during the ‘duty cycle’ proportion of a pulse period, and released to the output terminal 108 through the forward biased diode 114 when the switch 116 is open during the remainder of the pulse period. When the switch 116 is closed, the diode 114 is reverse biased and prevents current flowing back from the load 106 and capacitor 120 to ground. To a first approximation, in an ideal boost converter, the output voltage V_{O} is related to the input voltage V_{IN} by the formula:

V_{O}=V_{IN}/(1−d)

where d is the duty cycle, so that the output voltage V_{O} is a progressive function of d, that is to say that V_{O} increases when d increases.

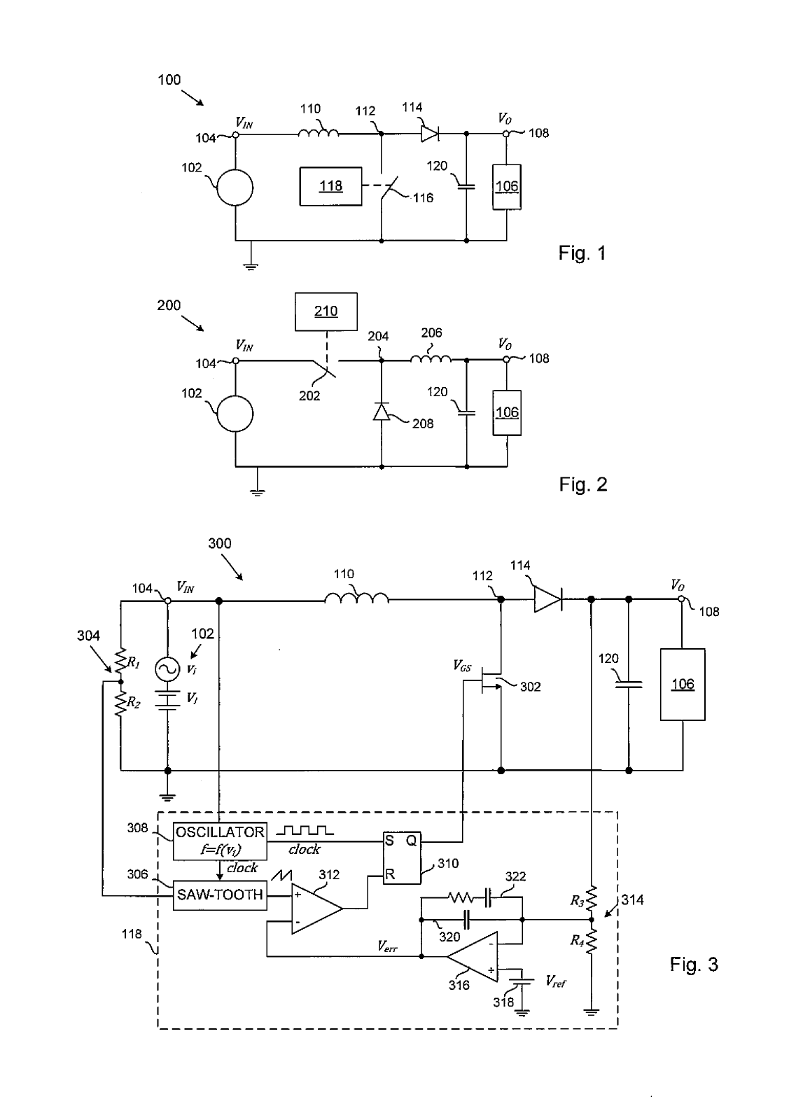

FIG. 2 shows the basic structure of a buck converter 200 to which the present invention can be applied, similar references being used in FIG. 2 for elements that are basically similar to those of the boost converter 100. The buck converter is connected to a source 102 of DC power at a voltage V_{IN} between an input terminal 104 and ground and supplies DC power at a voltage V_{O}, smaller than V_{IN}, to a load 106 connected between an output terminal 108 and ground. The basic structure of the buck converter 200 comprises a switch 202 connected in series between the input terminal 104 and a node 204, an inductor 206 connected in series between the node 204 and the output terminal 108, a diode 208 whose negative electrode is connected to the node 204 and whose positive electrode is connected to ground, a control module 210 for controlling the ON/OFF state of the switch 202 and hence the duty cycle of the converter and a capacitor 120 for smoothing the output voltage. Again, it will be appreciated that many variations on the basic structure shown are possible; for example the diode 208 may be replaced by a controlled switch element in a synchronous converter.

In operation of the buck converter 200 in continuous conduction mode, input energy is alternately stored in the inductor 206 when the switch 202 is closed during the ‘duty cycle’ proportion of a pulse period, and released by the inductor 206 to the output terminal 108 when the switch 202 is open during the remainder of the pulse period. When the switch 202 is closed, the voltage across the inductor is V_{L}=V_{IN}−Vₒ, the current through the inductor rises linearly, and the diode 208 is reverse biased by the voltage source 102 so that no current flows through it. When the switch 202 is open, the diode 208 is forward biased, the voltage across the inductor is V_{L}=−V_{O} (neglecting diode voltage drop), and the inductor current I_{L} decreases. To a first approximation, in an ideal buck converter, the output voltage V_{O} is related to the input voltage V_{IN} by the formula:

V_{O}=d*V_{IN}

where d is the duty cycle, so that the output voltage V_{O} is again a progressive function of d, that is to say that V_{O} increases when d increases.

FIG. 3 shows an example of a boost converter 300 in accordance with one embodiment of the invention. It will be appreciated that, with appropriate modifications which will be readily apparent, this example of an embodiment of the invention is also adaptable to the configuration of a buck converter or other DC-DC converters.

The direct current-to-direct current (‘DC-DC’) converter 300 comprises a control signal generator 118 for generating a pulse-width modulated (‘PWM’) control signal, and an output voltage generator for generating an output voltage V_{O} from an input voltage V_{IN} as a function of a duty cycle d of the PWM control signal. The control signal generator 118 comprises a feed-forward module for controlling both the duty cycle d and a repetition rate of the PWM control signal as regressive functions of the input voltage V_{IN} to compensate for variation in the input voltage. By ‘regressive function’ it is meant that the duty cycle and the repetition rate decrease when the input voltage increases.

In the DC-DC converter 300, the feed-forward module comprises a periodic signal generator for generating a periodic signal whose amplitude is a progressive function of the input voltage V_{IN} and whose repetition rate is a regressive function of the input voltage V_{IN}, and a comparator for comparing the periodic signal with a reference signal and producing a comparator output for controlling the duty cycle to compensate for variation in the input voltage.

In the DC-DC converter 300, the periodic signal generator comprises a saw-tooth signal generator for generating the periodic signal as a saw-tooth signal whose peak value is a progressive function of the input voltage. The saw-tooth signal generator comprises a capacitor, a current source that is a progressive function of the input voltage for charging the capacitor and a path for periodically discharging the capacitor.

The periodic signal generator comprises an oscillator whose repetition rate is a regressive function of the input voltage for controlling the repetition rate of the periodic signal. The control signal generator includes a feedback module for generating the reference signal as a function of the output voltage to compensate for variation in the output voltage.

A relationship between the duty cycle and the input voltage is of the form:

$$d = Q + \frac{P}{{V}_{in} + K}$$

$$and$$

$$Q = - α {V}_{err} , P = α {V}_{err} K + {V}_{err} M$$

where d is the duty cycle, V_{IN} is the input voltage, Vₑᵣᵣ is the reference signal and α, K and M are independent of the input voltage, the duty cycle and the output voltage.

In more detail, like the DC-DC converter 100, the DC-DC converter 300 is connected to a source 102 of DC power at a voltage V_{IN}, comprising a DC component V_{I} and an AC component vᵢ, between a positive polarity input terminal 104 and ground. The DC-DC converter 300 supplies DC power at a voltage V_{O}, greater than V_{IN}, to a load 106 connected between a positive polarity output terminal 108 and ground. An inductor 110 is connected in series between the input terminal 104 and a node 112. A diode 114 has a positive electrode connected to the node 112 and a negative electrode connected to the output terminal 108. A switch is provided by an n-type metal-oxide field-effect transistor (‘MOSFET’) 302 or other suitable semiconductor device, which has a drain connected to the node 112, a source connected to ground and a gate connected to the control signal generator 118 and to which the PWM control signal is applied to turn the MOSFET 302 ON and OFF.

The control signal generator 118 comprises a feed-forward module receiving a voltage supply from a voltage divider 304 connected between the input terminal 104 and ground. The voltage divider 304 comprises resistances R₁ and R₂ and the tap of the voltage divider supplies a voltage to a saw-tooth signal generator 306 so that the amplitude of the saw-tooth signal is a progressive function of the input voltage V_{IN}. The feed-forward module also comprises an oscillator 308 for producing a train (series) of rectangular clock pulses whose repetition rate f is a regressive function f(V_{IN}) of the input voltage V_{IN}. The train of clock pulses is applied to the set input S of a set-reset flip-flop 310 and also controls the repetition rate of the saw-tooth signal as a regressive function of the input voltage V_{IN}.

The saw-tooth signal from the generator 306 is applied to a positive input of a voltage comparator 312, whose output is applied to the reset input R of the flip-flop 310. A reference voltage Vₑᵣᵣ is applied to the negative input of the voltage comparator 312. The Q output of the flip-flop 310 is the PWM control signal applied as gate voltage to the MOSFET 302.

The control signal generator 118 includes a feedback module for generating the reference signal Vₑᵣᵣ as a function of the output voltage V_{O} to compensate for variation in the output voltage due to load variation, for example. The feedback module comprises a voltage divider 314 connected between the output terminal 108 and ground. The voltage divider 314 comprises resistances R₃ and R₄ and the tap of the voltage divider is connected to the negative input of an amplifier 316. The positive input of the amplifier 316 is connected to a reference voltage source 318. The output of the amplifier 316 is connected to its negative input through a feedback path 320 including a capacitor and a parallel feedback path 322 including the series connection of a capacitor and a resistor. The output Vₑᵣᵣ of the amplifier 316 applied to the negative input of the comparator 312 is a feedback signal corresponding to the difference between the actual output voltage V_{O} and a nominal output voltage defined by the reference voltage of the source 318 and the ratio of the resistances R₃ and R₄.

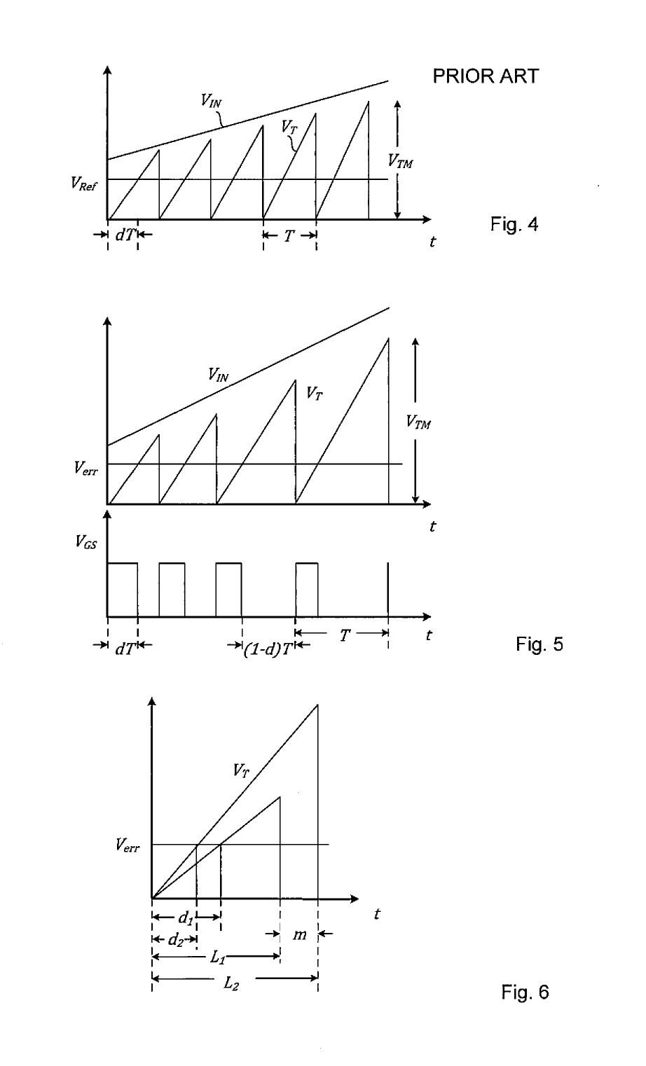

FIG. 4 shows signals produced in operation of a DC-DC converter of the kind described in the article “Open-Loop Peak Voltage Feed-forward Control of PWM Buck Converter”, by M. K. Kazimierczuk and A. J. Edstrom, IEEE Trans. Circuits Syst., I, vol. 47, pp 740-746, May, 2000. The input voltage V_{IN} from the DC power source is shown as varying linearly with time, in order to illustrate the relationship between the saw-tooth voltage V_{T} and the input voltage. The repetition rate and period T of the saw-tooth voltage V_{T} are constant and the control of the duty cycle d is obtained by modulation of the peak value V_{TM} of the saw-tooth voltage relative to a reference voltage V_{ref}.

FIG. 5 shows signals produced in operation of the DC-DC converter of FIG. 3. Again, the input voltage V_{IN} from the DC power source is shown as varying linearly with time, in order to illustrate the relationship between the saw-tooth voltage V_{T} and the input voltage. The peak value V_{TM} of the saw-tooth voltage from the saw-tooth generator 306 is modulated relative to the reference voltage Vₑᵣᵣ as a progressive function of the input voltage V_{IN}. In addition, the period T of the saw-tooth voltage is modulated as a progressive function of the input voltage V_{IN}. The repetition rate and the duty cycle d of the saw-tooth signal and the PWM control signal V_{GS} are regressive functions of the input voltage V_{IN} so as to tend to compensate for variation in said input voltage.

The PWM control signal V_{GS} shown in FIG. 5 is the Q output of the flip-flop 310 and is applied to the gate of the MOSFET 302. When the PWM control signal V_{GS} is asserted, the voltage V_{GS} goes positive to switch the MOSFET 302 ON. The PWM control signal V_{GS} is asserted when a rising edge of a clock pulse from the oscillator 308 sets the flip-flop 310 and the saw-tooth voltage V_{T} from the saw-tooth generator 306 is simultaneously set to zero. When the saw-tooth voltage V_{T} reaches and exceeds the reference voltage Vₑᵣᵣ from the amplifier 316, the output of the comparator 312 goes positive. The flip-flop 310 is reset and the PWM control signal V_{GS} is de-asserted, the voltage V_{GS} going to zero to switch the MOSFET 302 OFF. During the time dT that the MOSFET 302 is ON, corresponding to the duty cycle d, current from the power source 102 flows through the inductor 110 and the MOSFET 302 to store energy in the inductor 110, and current is supplied to the load 106 from the capacitor 120. During the remainder (1−d)T of the period T of the saw-tooth voltage, when the MOSFET 302 is OFF, energy from the inductor 110 is released to the load 106 and the capacitor 120.

The peak value V_{TM} of the saw-tooth voltage is a progressive function of the input voltage V_{IN} so that, although the period T of the saw-tooth voltage is also a progressive function of the input voltage V_{IN}, the rate of change V_{TM}/T of the saw-tooth voltage is a progressive function of the input voltage V_{IN}, and increases with increasing input voltage V_{IN}. This is illustrated in FIG. 6, which shows two values L₁ and L₂ of the period T corresponding respectively to a smaller and a larger value of the input voltage V_{IN} with L₂=L₁+m. Since the rate of change V_{TM}/T of the saw-tooth voltage is a progressive function of the input voltage V_{IN}, the time d₂L₂ that the MOSFET 302 is ON during the duty cycle d₂ of the longer period L₂ is shorter than the time d₁L₁ that the MOSFET 302 is ON during the duty cycle d₁ of the shorter period L₁.

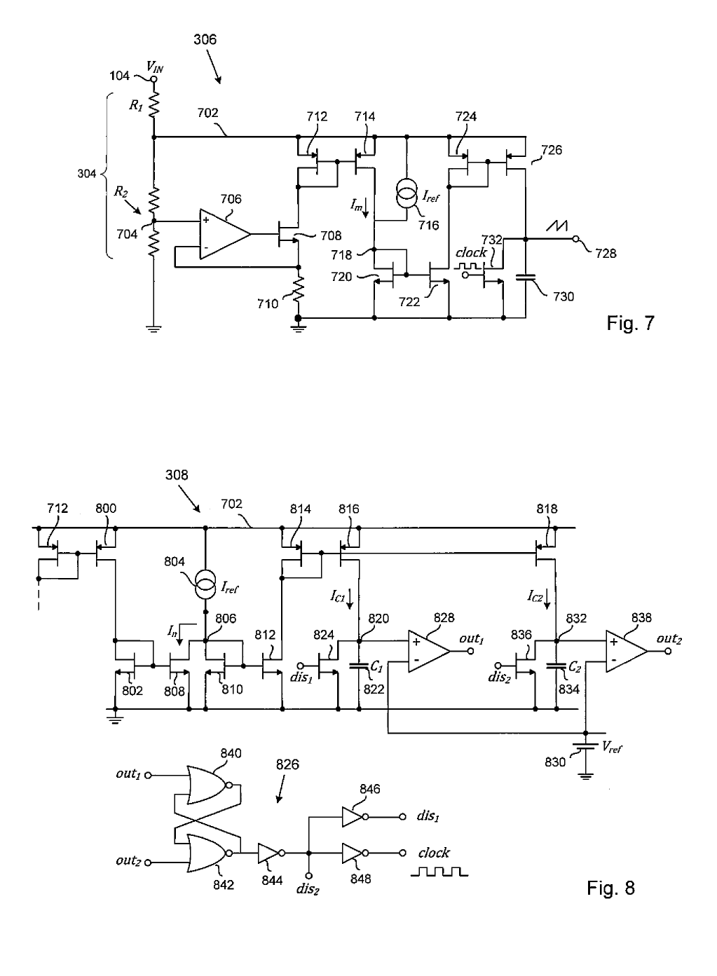

A schematic circuit diagram of an example of the saw-tooth generator 306 is shown in FIG. 7. The saw-tooth generator 306 comprises a positive rail 702 connected to the tap between the resistors R₁ and R₂ of the voltage divider 304. The resistor R₂ is itself a voltage divider with an intermediate tap 704 connected to a positive input of an amplifier 706. The amplifier 706 has an output connected to a gate of an NMOS transistor 708. A source of the NMOS transistor 708 is connected to ground through a resistor 710 and to a negative input of the amplifier 706. A drain of the NMOS transistor 708 is connected to a common gate of a pair of PMOS transistors (MOSFETs) 712 and 714 that are connected in a current mirror configuration. The sources of the MOSFETs 712 and 714 are connected to the positive rail 702. A drain of the MOSFET 712 is connected to the drain of the MOSFET 708 and the common gate of the MOSFETs 712 and 714. A constant current source 716 defining a reference current I_{ref} is connected between the positive rail 702 and a node 718 connected to the drain of the MOSFET 714.

The node 718 is connected to a common gate of a pair of n-type MOSFETs 720 and 722 connected in a current mirror configuration. The sources of the MOSFETs 720 and 722 are connected to ground. A drain of the MOSFET 720 is connected to the node 718 and the common gate of the MOSFETs 720 and 722. A drain of the MOSFET 722 is connected to a common gate of a pair of p-type MOSFETs 724 and 726 that are connected in a current mirror configuration. The sources of the MOSFETs 724 and 726 are connected to the positive rail 702. A drain of the MOSFET 724 is connected to the drain of the MOSFET 722 and the common gate of the MOSFETs 724 and 726.

A drain of the MOSFET 726 is connected to a saw-tooth generator output terminal 728. A capacitor 730 is connected between the output terminal 728 and ground. An n-type MOSFET 732 has a source connected to ground, a drain connected to the output terminal 728 and a gate connected to receive transient clock pulses from the oscillator 308.

In operation, the amplifier 706 biases the MOSFET 708 positively so that the voltage across the resistor 710 rises to that of the tap of the voltage divider R₂ that defines a current Iₘ in the MOSFET 708. The current Iₘ is mirrored in the pair of MOSFETs 712 and 714 and adds to the reference current I_{ref} before being mirrored in the pairs of MOSFETs 720 and 722 and 724 and 726. While the MOSFET 732 is OFF, the current (Iₘ+I_{ref}) from the drain of the MOSFET 726 charges the capacitor 730 substantially linearly. When the MOSFET 732 is ON, during the transient clock pulses at the start of each saw-tooth period, the capacitor 730 is rapidly discharged through the drain-source path of the MOSFET 732.

A schematic circuit diagram of an oscillator 308 in accordance with this embodiment of the invention is shown in FIG. 8. The oscillator 308 is supplied with a voltage proportional to the input voltage V_{IN} from the positive rail 702. A p-type MOSFET 800 is connected in a current mirror configuration with the MOSFET 712 of the saw-tooth generator 306. A gate of the MOSFET 800 is connected to the gate of the MOSFET 712 and a source of the MOSFET 800 is connected to the positive rail 702. A drain of the MOSFET 800 is connected to a drain of a MOSFET 802 whose source is connected to ground. A constant current source 804 defining a reference current I_{ref} (typically the same as the reference current in the constant current source 716) is connected between the positive rail 702 and a node 806 connected to the drain of an n-type MOSFET 808 that is connected in a current mirror configuration with the MOSFET 802. A source of the MOSFET 808 is connected to ground and a gate of the MOSFET 808 is connected to a gate and to the drain of the MOSFET 802 so that the MOSFET 808 draws a current Iₙ proportional to the input voltage V_{IN}.

The node 806 is connected to a common gate of a pair of n-type MOSFETs 810 and 812 that are connected in a current mirror configuration. The sources of the MOSFETs 810 and 812 are connected to ground. A drain of the MOSFET 810 is connected to the node 806 and the common gate of the MOSFETs 810 and 812. A drain of the MOSFET 812 is connected to a common gate of three p-type MOSFETs 814, 816 and 818 that are connected in a current mirror configuration. The sources of the MOSFETs 814, 816 and 818 are connected to the positive rail 702. A drain of the MOSFET 814 is connected to the drain of the MOSFET 812 and the common gate of the MOSFETs 814, 816 and 818.

A drain of the MOSFET 816 is connected to a node 820. A capacitor 822 is connected between the node 820 and ground. An n-type MOSFET 824 has a source connected to ground, a drain connected to the node 820 and a gate connected to receive pulses dis₁ from a bistable circuit 826. The node 820 is connected to a positive input of a comparator 828. A negative input of the comparator 828 is connected to a positive terminal of a source 830 of a reference voltage, whose negative terminal is connected to ground and an output of the comparator 828 produces a signal out₁.

A drain of the MOSFET 818 is connected to a node 832. A capacitor 834 is connected between the node 832 and ground. An n-type MOSFET 836 has a source connected to ground, a drain connected to the node 832 and a gate connected to receive pulses dis₂ from the bistable circuit 826. The node 832 is connected to a positive input of a comparator 838. A negative input of the comparator 838 is connected to the positive terminal of the source 830 of reference voltage and an output of the comparator 838 produces a signal out₂.

The bistable circuit 826 comprises a pair of cross-coupled NOR gates 840 and 842. An input of the NOR gate 840 receives the signal out₁ from the output of the comparator 828. An input of the NOR gate 842 receives the signal out₂ from the output of the comparator 838. An output of the NOR gate 840 is connected to an input of the NOR gate 842 and an output of the NOR gate 842 is connected to an input of the NOR gate 840. The output of the NOR gate 842 is connected to an inverter 844, whose output produces the pulses dis₂. The output of the inverter 844 is connected to an inverter 846, whose output produces the pulses dis₁. The output of the inverter 844 is also connected to an inverter 848, whose output produces the transient clock pulses, and which acts as a buffer for the clock signal used by the saw-tooth generator 306.

In operation, the difference current (I_{ref}−Iₙ) from the node 806 is mirrored in the MOSFETs 816 and 818. When the signal dis₁ is de-asserted, so that MOSFET 824 is OFF, the capacitor 822 charges with a current I_{C1}=(I_{ref}−Iₙ). Until the voltage across the capacitor 822 reaches the reference voltage of the source 830, the signal out₁ from the comparator 828 is de-asserted. Since the signal dis₁ is the inverse of the signal dis₂, the signal dis₂ is asserted, the MOSFET 836 is ON, the capacitor 834 is maintained discharged and the signal out₂ from the comparator 838 is de-asserted. Since the signal dis₂ is the inverse of the output of the NOR gate 842, the output of the NOR gate 842 is de-asserted. Since both inputs of the NOR gate 840 (the signal out₁ and the output of the NOR gate 842) are de-asserted, the output of the NOR gate 840 is asserted.

When the voltage across the capacitor 822 reaches the reference voltage of the source 830, the signal out₁ from the comparator 828 is asserted. The output of the NOR gate 840 is de-asserted, the output of the NOR gate 842 is asserted since both its inputs are now de-asserted. The signal dis₂ is de-asserted, so that MOSFET 836 is OFF, the capacitor 834 charges with a current I_{C2}=(I_{ref}−Iₙ). The cycle switches bistably, the transient clock pulses being generated on the falling edges of the signal dis₂.

In the saw-tooth generator 306, the input voltage V_{IN} is converted to current Iₘ by the resistor divider 304 and follower amplifier 706, 708, 710. The sum of the current Iₘ and the reference current I_{ref} is the whole current used to charge the capacitor 730. The transient clock from the oscillator 308 discharges the capacitor 730 periodically, and the saw-tooth signal V_{T} is generated with a frequency f that is a regressive function of the input voltage V_{IN}. In addition, the amplitude V_{TM} and ramp slope V_{TM}/T are both modulated by the input voltage V_{IN} of the converter. The currents Iₘ and Iₙ are arranged to be similar and are also proportional to the input voltage V_{IN}. The duration of each bistable phase of the oscillator depends on the mirrored currents I_{C1} and I_{C2} and the capacitances C₁ and C₂ of the capacitors 822 and 834. When the input voltage V_{IN} increases, Iₙ increases at the same time. As a result, the charging currents I_{C1} and I_{C2} are reduced and make the frequency of clock slower.

The amplitude V_{TM} of the saw-tooth signal can be written as:

$${V}_{TM} = \frac{{I}_{m} + {I}_{ref}}{C} T$$

In this example, the currents I_{C1} and I_{C2} are proportional to (I_{ref}−Iₙ) and the currents Iₘ and Iₙ are proportional to V_{IN}. It can be shown that:

$$\frac{1}{f} = T = \frac{{V}_{ref} {C}_{1}}{{I}_{{C}_{1}}} + \frac{{V}_{ref} {C}_{2}}{{I}_{{C}_{2}}}$$

Since the duty cycle d=Vₑᵣᵣ/V_{TM}, it can be shown that

$$d = Q + \frac{P}{{V}_{in} + K}$$

$$and$$

$$Q = - α {V}_{err} , P = α {V}_{err} K + {V}_{err} M$$

where α, K and M are independent of the input voltage, of the duty cycle and of the output voltage.

The feedback module acts to correct for residual variation in the output voltage due to load variation, for example. The reference signal Vₑᵣᵣ is a regressive function of the difference between the actual output voltage V_{O} and its nominal value. If this difference increases, the reference signal Vₑᵣᵣ decreases and the saw-tooth generator defines a decreased duty cycle d which reduces the actual output voltage V_{O} to compensate.

In the foregoing specification, the invention has been described with reference to specific examples of embodiments of the invention. It will, however, be evident that various modifications and changes may be made therein without departing from the broader spirit and scope of the invention as set forth in the appended claims.

The terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed. Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “de-assert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also, the invention is not limited to physical devices or units implemented in non-programmable hardware but can also be applied in programmable devices or units able to perform the desired device functions by operating in accordance with suitable program code.

In the claims, the word ‘comprising’ does not exclude the presence of other elements or steps than those listed in a claim. Further, the terms “a” or “an”, mean one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A direct current-to-direct current (‘DC-DC’) converter, comprising:
a control signal generator for generating a pulse-width modulated (‘PWM’) control signal; and
an output voltage generator for generating an output voltage from an input voltage as a function of a duty cycle of said PWM control signal,
wherein said control signal generator comprises a feed-forward module for controlling both said duty cycle and a repetition rate of said PWM control signal as regressive functions of said input voltage to compensate for variation in said input voltage.

2. The DC-DC converter of claim 1, wherein said feed-forward module comprises a periodic signal generator for generating a periodic signal whose amplitude is a progressive function of said input voltage and whose repetition rate is a regressive function of said input voltage, and a comparator for comparing said periodic signal with a reference signal and producing a comparator output for controlling said duty cycle to compensate for variation in said input voltage.

3. The DC-DC converter of claim 2, wherein said periodic signal generator comprises a saw-tooth signal generator for generating said periodic signal as a saw-tooth signal whose peak value is a progressive function of said input voltage.

4. The DC-DC converter of claim 3, wherein said saw-tooth signal generator comprises a capacitor, a current source that is a progressive function of said input voltage for charging said capacitor, and a path for periodically discharging said capacitor.

5. The DC-DC converter of claim 2, wherein said periodic signal generator comprises an oscillator whose repetition rate is a regressive function of said input voltage for controlling said repetition rate of said periodic signal.

6. The DC-DC converter of claim 2, wherein said control signal generator includes a feedback module for generating said reference signal as a function of said output voltage to compensate for variation in said output voltage.

7. The DC-DC converter of claim 6, wherein a relationship between said duty cycle and said input voltage is of the form:
$$d = Q + \frac{P}{{V}_{in} + K}$$
$$and$$
$$Q = - α {V}_{err} , P = α {V}_{err} K + {V}_{err} M$$
where d is said duty cycle, Vᵢₙ is said input voltage, Vₑᵣᵣ is said reference signal and α, K and M are independent of said input voltage, said duty cycle and said output voltage.

8. A direct current-to-direct current (‘DC-DC’) converter, comprising:
a control signal generator for generating a pulse-width modulated (‘PWM’) control signal; and
an output voltage generator for generating an output voltage from an input voltage as a function of a duty cycle of the PWM control signal,
wherein the control signal generator comprises,
a feed-forward module for controlling both the duty cycle and a repetition rate of the PWM control signal as regressive functions of the input voltage to compensate for variation in the input voltage,
wherein the feed-forward module comprises a periodic signal generator for generating a periodic signal whose amplitude is a progressive function of the input voltage and whose repetition rate is a regressive function of the input voltage, and a comparator for comparing the periodic signal with a reference signal and producing a comparator output for controlling the duty cycle to compensate for variation in the input voltage, and
wherein the periodic signal generator comprises a saw-tooth signal generator for generating the periodic signal as a saw-tooth signal whose peak value is a progressive function of the input voltage.

9. The DC-DC converter of claim 8, wherein said saw-tooth signal generator comprises a capacitor, a current source that is a progressive function of said input voltage for charging said capacitor, and a path for periodically discharging said capacitor.

10. The DC-DC converter of claim 8, wherein said periodic signal generator comprises an oscillator whose repetition rate is a regressive function of said input voltage for controlling said repetition rate of said periodic signal.

11. A method of direct current-to-direct current (‘DC-DC’) conversion, comprising:
generating a pulse-width modulated (‘PWM’) control signal;
generating an output voltage from an input voltage as a function of a duty cycle of said PWM control signal; and
controlling both said duty cycle and a repetition rate of said PWM control signal using feed-forward control as regressive functions of said input voltage to compensate for variation in said input voltage.

12. The DC-DC conversion method of claim 11, wherein generating said PWM control signal includes generating a periodic signal whose amplitude is a progressive function of said input voltage and whose repetition rate is a regressive function of said input voltage, and controlling said duty cycle includes comparing said periodic signal with a reference signal to compensate for variation in said input voltage.

13. The DC-DC conversion method of claim 12, wherein said periodic signal is a saw-tooth signal whose peak value is a progressive function of said input voltage.

14. The DC-DC conversion method of claim 13, wherein generating said saw-tooth signal comprises charging a capacitor using a current that is a progressive function of said input voltage, and periodically discharging said capacitor.

15. The DC-DC conversion method of claim 12, wherein generating said periodic signal includes using an oscillator to generate a signal whose frequency is a regressive function of said input voltage for controlling said repetition rate of said periodic signal.

16. The DC-DC conversion method of claim 12, wherein the reference signal is generated using feedback control as a function of said output voltage to compensate for variation in said output voltage.

17. The DC-DC conversion method of claim 16, wherein a relationship between said duty cycle and said input voltage is of the form:
$$d = Q + \frac{P}{{V}_{in} + K}$$
$$and$$
$$Q = - α {V}_{err} , P = α {V}_{err} K + {V}_{err} M$$
where d is said duty cycle, V_{IN} is said input voltage, Vₑᵣᵣ is said reference signal and α, K and M are independent of said input voltage, said duty cycle and said output voltage.
